(19) United States
(12) Patent Application Publication
(10) Pub. No.: US 2003/0197690 A1
(43) Pub. Date: Oct. 23, 2003

(54) Computer input system

(76) Inventor: Oleg N. Zimenkov, St. Catharines (CA)

Correspondence Address: GOWLING LAFLEUR HENDERSON LLP, Suite 560, 120 King Street West, P.O. Box 1045 LCD1, Hamilton, ON, L8N 3R4, CA

(21) Appl. No.: 10/125,385

(22) Filed: Apr. 19, 2002

(51) Int. Cl. G09G 5/00

(52) U.S. Cl. 345/179

(57) ABSTRACT

An input system for a computer has a hand-held movable pen, a stationary part electrically connectable to a computer, and a flexible part connecting the pen to the stationary part. The stationary part has a working surface over which the pen is manually moveable, and a light source is operable to emit light from a tip of the pen. The input system also has a first layer of transparent slits and light scattering or fluorescent strips below the working surface and extending parallel to each other in one direction and a second layer of transparent slits and reflecting or fluorescent strips below the first layer and extending parallel to each other in a direction perpendicular to the one direction. Movement of the pen over the working surface causes light from the tip of the pen either to be scattered upwardly by the first layer and/or to pass downwardly to the first and second layers or to stimulate light fluorescence from the first and second layers in a manner indicative of X and Y axis positions of the pen on the working surface. At least one light sensor is provided to detect scattered and/or transmitted or otherwise varied light, and the stationary part has a converting circuit operable to convert the sensed light to electrical signals indicative of at least an X or Y position of the pen and transmit the signals to a computer to effect corresponding positioning of a cursor on a visual display device thereof.

### BACKGROUND OF THE INVENTION

In the majority of present days computers, the well-known device known as a mouse determines the position of the cursor on the monitor. There are several optical mouse systems using perpendicularly oriented passive line-type patterns on the surface, over which the mouse is manually moved, to distinguish a movement along X-axis from a movement along Y-axis. For example, U.S. Pat. No. 4,364,035 (Kirsch) issued Dec. 14, 1982 describes an electro-optical mouse employing a movable detector means which slides over a surface having passive, position related marks of two colours. The detector means includes a light source, which sequentially alternates between one colour and the other. A four-quadrant light detector is positioned for receiving the light reflected from the two groups of lines. By clocking emission of the two colours and detector output signal, electrical outputs are obtained representing reflection from the first and second groups of lines. Such signals are used to establish line crossings, thereby deriving a position signal for a cursor. Another example, U.S. Pat. No. 4,647,771 (Kato) issued Mar. 3, 1987 describes an optical mouse for inputting a cursor position including first and second lines patterns formed on opposite surface of a transparent substrate, with the lines of the first and second line pattern being perpendicular. The line pattern are illuminated by a light source in the movable mouse body, which also includes an optical system and detecting elements for separately detecting light reflected from the first and second patterns. Because the first and second patterns are located at different distances from the optical system, light reflected from two patterns can be separately focused to prevent interference between two patterns.

Both described systems use two light reflecting line-type patterns oriented perpendicularly to each other. A distinguish between X- and Y-axis movements are based on the difference of light colours, like in first example, or on difference of distances between optical system and reflecting patterns, like in second example. Therefore, a necessity to use relatively bulky optical systems and an inevitable condition to keep strictly definite orientation between optical systems and reflecting patterns, due to nature of optical reflection effect, which is the base of operational procedures, leads to a situation when a movable part in both described systems should have dimensions at least as commonly used mouse.

However, a mouse is not suitable for applications such as drawing and hand writing. There are consequently being attempts to provide a cursor control device can be used for drawings and hand writing. For example, U.S. Pat. No. 4,922,236 (Heady) issued May 1, 1990 describes a relative motion cursor control device configured as a pen. Two bungles of optical fibres are orthogonally arrayed with hexagonal packing against a passive reference image. Quadrature logic translates edge crossings into an unambiguous motion in an X-Y plane. Each optical fibre in the bundles acts as both source and receptor of light to and from the spot under it in the referent image.

Operation of the system described in the above patent is based on light reflection by the surface of an appropriate pad. The pad has a plurality of reflecting strips, and distinction between X and Y movement direction is based on the difference between indexes of reflection for different wavelengths corresponding to X and Y oriented strips. The device can function properly only when the determined orientation of the device relative to the pad is precisely maintained. Operation by a user is thus somewhat different from ordinary handwriting by a pen or pencil when a writer has full freedom in writing device orientation.

U.S. Pat. No. 5,945,981 (Paull et al) issued Aug. 31, 1999 describes a computer input system which uses a pen-type input device and a receiver. The pen-type input device includes an LED, at least one switch, a rechargeable battery, and a control circuit. The receiver has one or more light-detecting elements connected to position computation circuitry. The light-detecting element or elements are a two-dimensional PSD, two one-dimensional PSD or a four-division photodiode. Optical lenses, optical filters and aperture plates are positioned before the light detecting element(s) to improve the signal-to-noise ratio of the system. The computation circuitry receives the signal from the light-detecting elements, digitizes them, and computes the coordinates of the pen which are then outputted to a host computer.

Taking into account resolution of a PSD and geometry of the system, it is possible to ascertain that the system has low resolution, not more than 100 dpi. Thus, operational procedure is then different from ordinary handwriting when the writer carries out the majority of necessary movements as an amplitude of approximately one inch, which corresponds to the average geometrical length of one handwritten word, using only the operator's fingers with a stable stationary wrist.

It is therefore an object of the invention to provide a computer input system which overcomes the disadvantages of the prior art.

### SUMMARY OF THE INVENTION

According to the invention, an input system for a computer has a hand-held movable pen, a stationary part electrically connectable to a computer, a flexible part connecting the pen to the stationary part, the stationary part having a working surface over which the pen is manually moveable, a light source operable to emit light from a tip of the pen, a first layer of transparent slits and light scattering or fluorescent strips below the working surface and extending parallel to each other in one direction, and a second layer of transparent slits and reflecting or fluorescent strips below said first layer and extending parallel to each other in a direction perpendicular to the said one direction. Movement of the pen over the working surface causes light from the tip of pen either to be scattered upwardly by the first layer and/or to pass downwardly to said first and second layers or to stimulate light fluorescence from said first and second layers in a manner indicative of X and Y axis positions of the pen on the working surface, at least one light sensor being provided to detect said scattered and/or transmitted or otherwise varied light, and the stationary part has converting means operable to convert the sensed light to electrical signals indicative of at least an X or Y position of the pen and transmits said signals to a computer to effect corresponding positioning of a cursor on a visual display device thereof.

The light sensor may detect light scattered and/or transmitted or otherwise varied after transmission thereof into the tip of the pen additionally or alternatively. A light sensor may be located adjacent the second layer to detect light transmitted thereinto.

The first layer may have a plurality of light transmitting relatively wide and relatively narrow slits and light scattering relatively wide and relatively narrow strips. The second layer may have a plurality of light transparent relatively wide and relatively narrow slits and light reflecting relatively wide and relatively narrow strips.

The first layer may have a plurality of light transmitting relatively wide and relatively narrow slits and relatively wide and relatively narrow trenches. The trenches containing fluorescent material which emits light at a first wavelength when excited by light from the pen, and the second layer has a plurality of light transmitting relatively wide and relatively narrow slits and relatively wide and relatively narrow second trenches, the second trenches containing fluorescent material which emits light at a second wavelength when excited by light from the pen. The pen may have a vertically downwardly extending inoperative position with a tip thereof at the lower end. The working surface may also have touch switches operable by engagement by the pen to effect movement of the cursor.

### BRIEF DESCRIPTION OF THE DRAWINGS

Embodiments of the invention will now be described, by way of example, with reference to the accompanying drawings, of which:

FIG. 1 is a perspective view of an input system in accordance with one embodiment of the present invention connected to a host computer, the input device being in its inoperative position,

FIG. 2 is a similar view on an enlarged scale of the input system shown in FIG. 1,

FIG. 3 is a side view of the input system of FIG. 2,

FIG. 4 is a similar view but showing the input device in an operative position,

FIG. 5 is an exploded perspective view of the parts associated with the working surface for the input device,

FIG. 6 is a schematic view of the optical system in the stationary part of the input system,

FIG. 7 is a schematic side view of optical interaction between the input device (pen) and the working surface of the stationary part, when the light beams are internally reflected in the lower mask,

FIG. 8 is a similar view showing the optical interaction when the light beams are partially reflected before entering the lower optical mask,

FIG. 9 is a similar view showing when the light beams are totally reflected before entering the lower optical mask,

FIG. 10 is a similar view showing the optical interaction when the light beams are scattered before entering the lower optical mask,

FIG. 11 is a similar view showing the optical interaction when the light beams are reflected by the lower optical mask,

FIG. 12 is a schematic plan view of the working surface of the stationary part,

FIG. 13 is a signal produced in the electronic circuit during movement of the pen from point A to point B of FIG. 12,

FIG. 14 shows the signal related to distance determination and produced in the electronic circuit during movement of the pen from point A to point B of FIG. 12,

FIG. 15 shows a signal related to movement direction determination produced in the electronic circuit during movement of the pen from point A to point B of FIG. 12,

FIG. 16 shows a signal produced in the electronic circuit during movement of the pen from point B to point A of FIG. 12,

FIG. 17 shows a signal related to distance determination produced in the electronic circuit during movement of the pen from point B to point A of FIG. 12,

FIG. 18 shows a signal related to movement direction determination produced in the electronic circuit during movement of the pen from point B to point A of FIG. 12,

FIG. 19 is an exploded perspective view of the upper and lower optical masks forming the working surface in accordance with a second embodiment of the invention, and

FIG. 20 is a schematic view of an alternative optical system.

### DESCRIPTION OF PREFERRED EMBODIMENTS

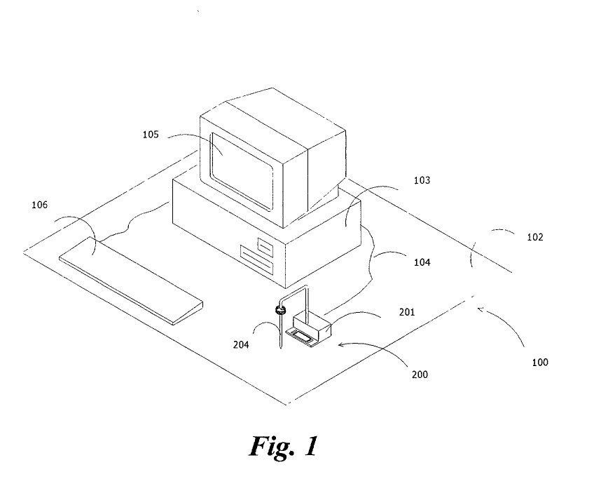

Referring to the drawings, FIG. 1 shows a computer assembly 100 having an input system 200 in accordance with one embodiment of the invention. The input system 200, shown located on a desk top 102, is electrically connected to a computer 103 by a cable 104 and comprises a stationary part 201 and a movable part 204 in the form of a pen. The computer 103 has a visual display 105 and a keyboard 106.

As will be described in more detail later, light-detecting elements located inside the stationary part 201 receives light from the pen 204 as the pen 204 is moved relative to the stationary part 201. The stationary part 201 measures transverse and longitudinal movement of the pen 204 and generates signals which indicate X and Y movements of the pen 204 and outputs the signals via cable 104 to the computer 103. The computer 103 converts the signals to cursor movements on the visual display device 105.

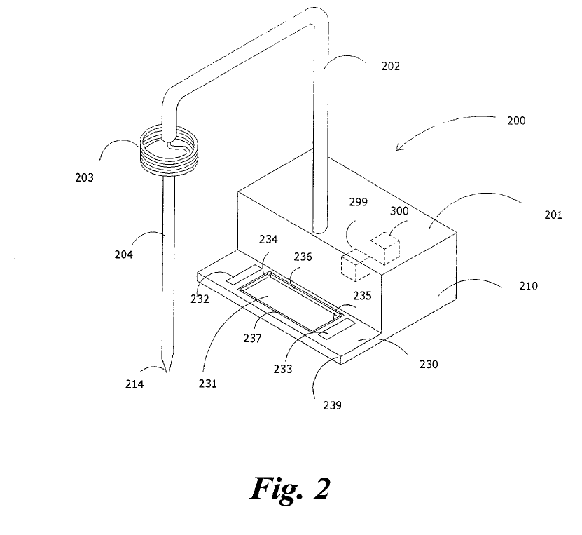

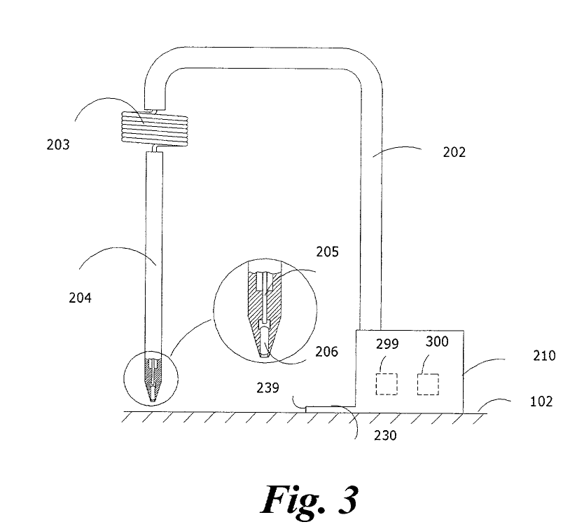

Referring now to FIGS. 2 to 4, the stationary part 201 and the pen 204 of the input system 200 are mechanically connected to each other by a rigid tubular holding part 202 and a spring holding part 203. The rigid and flexible parts 202, 203 contain an optical connection in the form of optical fibre 205 and electrical connection for pressure and touch switches. When inoperative, the pen 204 hangs vertically in a “tip-down” configuration as shown in FIGS. 2 and 3 so that the pen 204 is ready for immediate use.

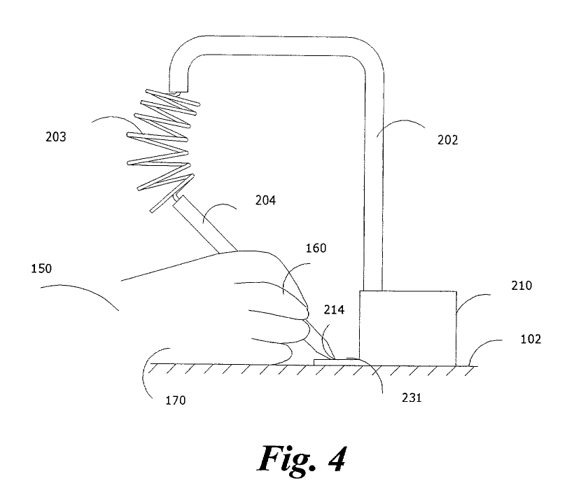

FIG. 4 shows the pen 204 in use by a user who puts his or her hand 150 on the desk top 102, grasps the pen 204 by their fingers 160 and begin to move the pen 204 by each of their fingers 160, keeping the wrist 170 still, in such a manner that the tip 214 of the pen 204 begins to move over the working area of a front panel 230 of the stationary part 201.

The pen 204 contains an electrical pressure switch (not shown), optical fibre 205 and a focussing element 206. The pressure switch is analogous to the left button of a conventional computer mouse and is used for click and drag functions, selection of menu options or other computer input commands. To actuate the pressure switch, the user increases downward pressure on the pen 204.

The stationary part 201 has a housing 210 which contains an electronic circuit 299 and an optical system 300 which connects light emitting and light detecting elements with the optical fibre 205. The front panel 230 has a working area 231 and touch switches 232 to 237. The switches 232, 233 perform similar functions to the space bar of a computer keyboard and the right button of a computer mouse respectively. The switches 234 to 237 are located adjacent the pages of the working area 231. When the pen 204 touches any of these switches, the electronic circuit 299 generates a signal to shift the cursor on the display device 105 by a predetermined number of pixels in the appropriate direction. The switch 234 produces shift to the left, switch 235 produces shift to the right, switch 236 produces upward shift and switch 237 produces downward shift.

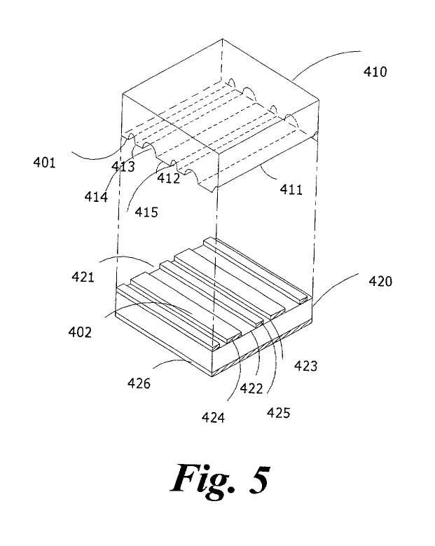

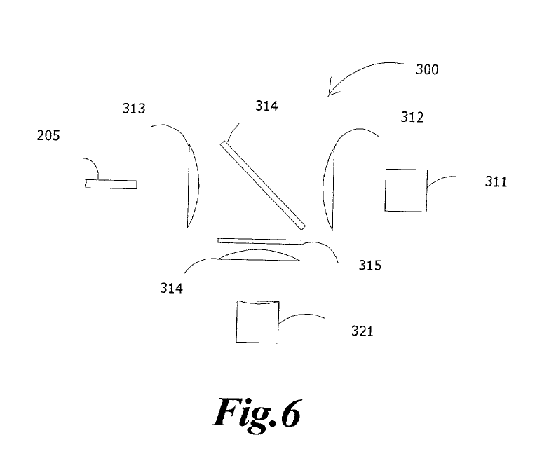

As shown in FIG. 5, the working surface 231 is formed by two plates 410, 420. Plate 410 is mounted on top of plate 420, with the bottom 411 of the pate 410 engaging the top 421 of the plate 420. Both plates 410, 420 are made from light transparent material, preferably optical glass. The bottom 411 of the upper plate 410 has a plurality of light transparent wide slits 412 and narrow slits 413 and light scattering wide strips 414 and narrow strips 415, thereby forming an optical transmitting-scattering mask 401. The slits 412, 413 are parallel to each other and perpendicular to the front edge 239 of the front panel 230. The scattering strips 414, 415 may be scratches on the glass surface.

The top 421 of the lower plate 420 has a plurality of light transparent wide slits 422 and narrow slits 423 and light reflecting wide strips 424 and narrow strips 425 which form an optical transmitting-reflecting mask 402. The slits 422, 423 are parallel to each other and parallel to the front edge 239 of the front panel of 230. The plate 420 has a reflective covering 426 on its bottom.

The stationary part 410 also contains the optical system 300 which includes light-emitting element 311, light-detecting element 321 and an end of optical fibre 205. The optical system 300 also includes lenses 312, 313 and beam splitter 314 to ensure effective light transmission through the optical fibre 205. Optical filter 315 is also included to increase signal/noise ratio.

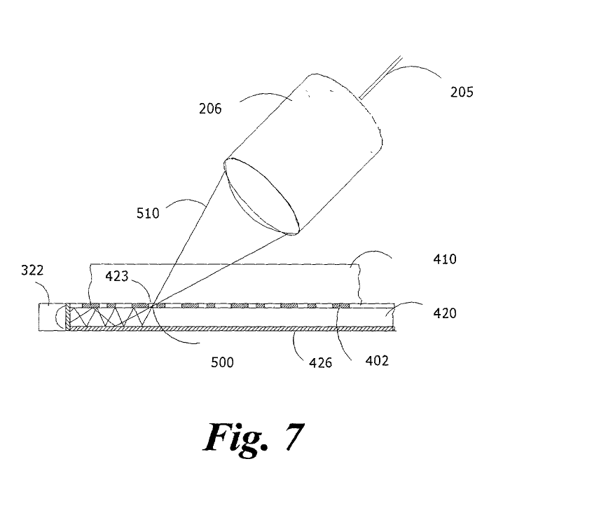

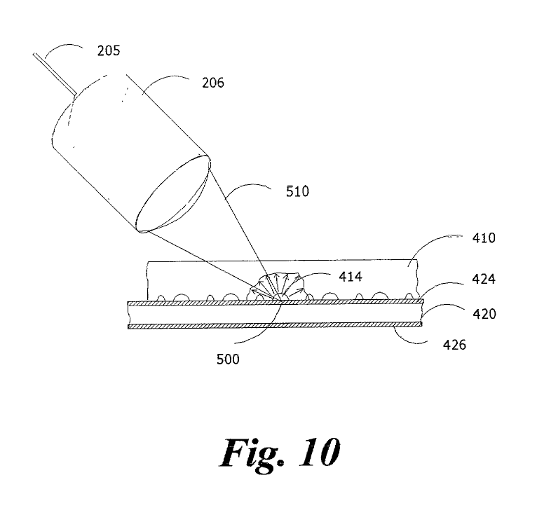

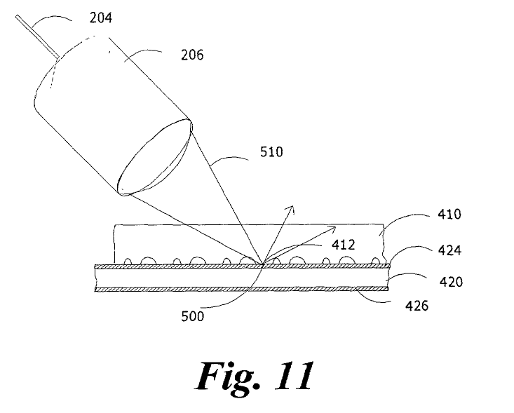

FIGS. 7 to 11 shows schematic views of interaction between the pen 204 and the working area 231 of the front panel 230. As shown, the pen 204 has the same angular orientation relative to the working area 231 in all of these figures. The geometrical axis of the pen 204 lies in a plane perpendicular to the plane of the surface of the working area 231 and is inclined at a 45° angle to the front edge 239 of the front panel 230 and a 45° angle to the surface of the working area 231. FIGS. 7 to 9 show views from a position on the line parallel to the front edge 239, and FIGS. 10 and 11 show views from a position lying on the line perpendicular to the front edge 239.

FIG. 7 shows the effect when light beams 510 emitted from the optical fibre 205 and focussed by the lens 206 pass through the upper plate 410 and through transparent slits 412 or 413 of the transmitting-scattering mask 401, form light spot 500 in a transparent narrow slit 423 of the transmitting-reflecting mask 402, and reach a light-detecting element 322 at the left hand edge of the mask 402 after numerous reflections from the reflective covering 426 and reflecting strips 424, 425.

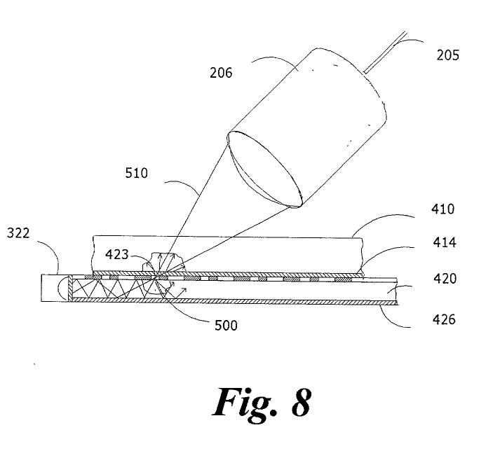

FIG. 8 shows light beams 510 passing through upper plate 410 and contacting scattering strips 414, 415 of the transmitting-scattering mask 401. In this case, light is scattered upward into the plate 410 and downwardly to the plate 420, passing through a transparent narrow strip 423 of the transmitting-reflecting mask 402. Light in the lower plate 420 reaches the light-detecting element 322 after numerous reflections from the reflecting cover 426 and reflecting strips 424, 425.

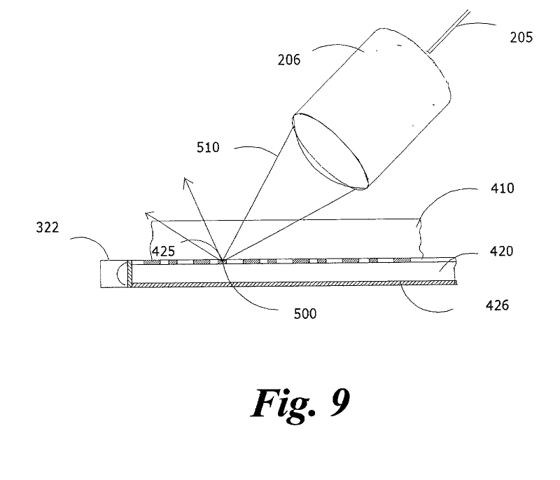

FIG. 9 shows when light beams 510 pass through plate 410 and pass through transparent slits 412 or 413 of the transmitting-scattering mask 401 to form the light spot 500 on the reflecting strip 425 of the transmitting-reflecting mask 402. The light is reflected upwardly, missing both light-detecting elements 321 and 322.

FIG. 10 shows when light beams 510 pass through plate 410 to form light spot 500 on the wide scattering strip 414 of the transmitting-scattering mask 401 and are scattered upwardly to create a secondary Lambert light source. The output end of the optical fibre 205 and the area scattering in the strip 414 are in optically conjugated planes due to the distances between the fibre 205, lens 206, the end of the pentip 214 and the thickness of the plate 410. An image of the secondary Lambert light source is formed on the output end of the optical fibre 205. After scattering on the strip 414, light goes back into the optical fibre 205 to pass through the pen 204, flexible holding part 203, rigid holding part 202, and out of the other end of the optical fibre 205 into the optical system 300. The light then passes through lens 313, is partially reflected by beam splitter 314, passes through optical filter 315 and lens 315 and finally reaches light-detecting element 321.

FIG. 11 shows when light beams 510 pass through plate 410 to form light spot 500 on a transparent wide slit 413 of the transmitting-scattering mask 401 and are reflected upwardly by reflecting strips 424, 425 of the transmitting-reflecting mask 402. Thus, no light reaches the light detecting element 321. Only a precise vertical orientation of the pen 204 would provide opportunity for reflected light to reach light-detecting element 321 in this situation. However, the usual manner of holding a pen makes the possibility of such an occurrence very small.

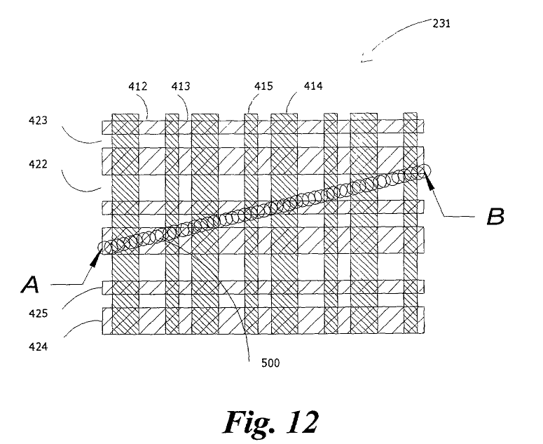

Referring now to FIG. 12, parts of both the transmitting-scattering mask 401 and the transmitting-reflecting mask 402 are shown, these being formed by a plurality of the transparent slits 402, 413, 422 and 423, scattering strips 414, 415 and reflecting strips 424, 425. A schematic trajectory of the light spot 500 moving between points A and B is also shown.

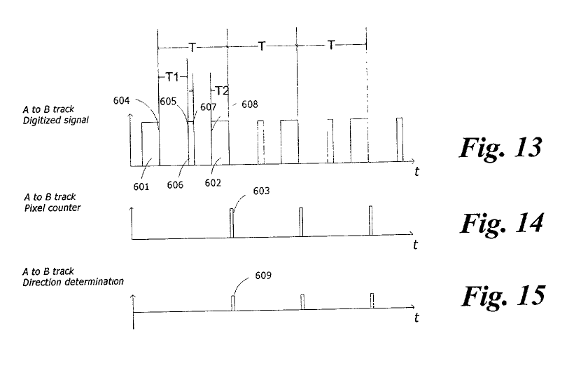

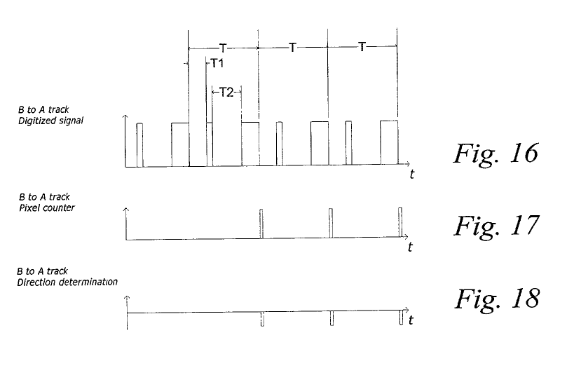

FIGS. 13 to 15 show time diagrams of signals produced in electronic circuit 299 during travel of the light spot 500 from point A to point B to determine X movement of the cursor, and FIGS. 16 to 18 show time diagrams of signals produced in the electronic circuit 299 showing travel of the light spot 500 travelling from point B to point A to determine X movement of the cursor. The speed of the movement of light spot 500 is assumed to remain constant so far as these figures are concerned. The process of analysis is the same for X coordinates which are determined by signals from light-detecting element 321, and Y coordinates which are determined by signals from light detecting element 322.

FIG. 13 shows the signals from light-detecting element 321 after digitization in the electronic circuit 299. When electronic circuit 299 detects two impulses 601, 602 with the same duration, impulse 603 shown in FIG. 14 is generated and used to count absolute value of movement along the X axis. At the same time, the electronic circuit 299 determines time intervals T1 and T2. The interval T1 is the time between the back edge 603 of the first impulse 601 of the period T and the front edge 605 of the intermediate impulse 606. The interval T2 is the time between the back edge 607 of the intermediate impulse 606 and the front edge 608 of the last in the period impulse 602. The electronic circuit 299 determines the difference between time interval T2 and time interval T1 and generates a normalized signal 609 shown in FIG. 15 which has a polarity consistent with the sign of the result of the subtraction T1−T2. A positive result of the subtraction indicates movement from left to right. An analogous analysis can be applied to FIGS. 16 to 18. If the result of the subtraction T1−T2 is negative, then light spot 500 has moved in the opposite direction.

In the above described embodiment, optical separation of information about light spot movement along the strip-type masks was achieved on the basis that movement in the X-direction produces scattering upwardly and movement in the Y-direction produces transmission downwardly.

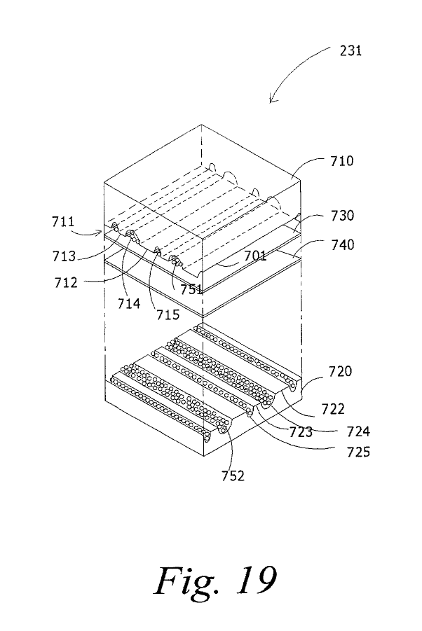

As will now be described with reference to FIG. 19, another embodiment of the invention operates on the basis that movement in the X-direction produces fluorescence with a first wavelength and movement in the Y-direction produces fluorescence on a second wavelength. This involves changing plates 410 and 420 and optical system 300 and using an achromatic lens instead of gradient 206.

FIG. 19 shows plates 710, 720, 730 and 740 which contact each other and together form the working area 321. Again, all the plates are made from light transparent material, preferably optical glass.

A plurality of light transparent wide slits 712 and narrow slits 713 and wide trenches 714 and narrow trenches 715 arrange in a predetermined order are provided on the bottom of plate 710 to form an optical transmitting-fluorescent mask 701. The slit 712, 713 and trenches 714, 715 are parallel to each other and perpendicular to the front edge 239 of the front panel 230. The trenches 714, 715 are filled with fluorescent material 751 which emit light at wavelength Lambda-1 when excited by light from light-emitting element 311.

The plate 720 with slits 722, 723 and trenches 724, 725 are identical to those on plate 710 but are perpendicular thereto. Trenches 724, 725 are filled with fluorescent material 752 which emits light at another wavelength Lambda-2 when excited by light-emitting element 311.

Fluorescent material 751, 752 are preferably small fluorescent particles, for example such as those produced by Microparticles GmBH of Berlin, Germany. Thin transparent plates 730, 740 are used to keep the fluorescent materials in the respective trenches.

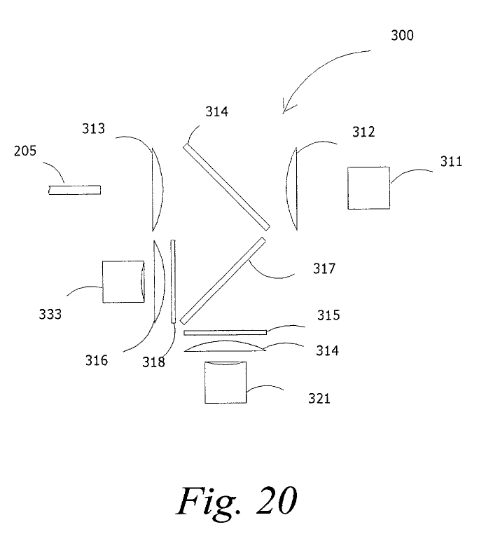

FIG. 20 shows a modified optical system in accordance with a further embodiment of the invention with additional lens 316, beam splitter 317, optical filter 318 and light-detecting element 333, which has the same function as light detecting element 322 in the previous embodiment. This eliminates the need to detect light which continues to go downwardly, so that a thinner working area 231 can be used.

When a user activates the above described systems by moving the pen into direct contact between its tip and the surface of the working area, light emitted by the light-emitting element is transmitted through the optical fibre and optional focussing optics in the tip of the pen and illuminates both masks at the working area of the stationary part. As the pen is moved across the surface of the working area, one light-detecting element periodically receives light scattered up from the X-oriented mask, or emitted up due to fluorescence from the X-oriented mask. Another light detecting element periodically receives light transmitted down through the Y-oriented mask or emitted up due to fluorescence at another wavelength from the Y-oriented mask. The electronic circuit counts electrical impulses in accordance with the relative duration from the light-detecting element or elements and generates signals to form X, Y coordinates of the cursor on the display device.

The advantages of the invention will now be readily apparent to a person skilled in the art from the foregoing description of the preferred embodiments. Other embodiments will also now be readily apparent to a person skilled in the art, the scope of the invention being defined in the appended claims.

1. An input system for a computer having:
a hand-held movable pen,
a stationary part electrically connectable to a computer,
a flexible part connecting the pen to the stationary part,
the stationary part having a working surface over which the pen is manually moveable,
a light source operable to emit light from a tip of the pen,
a first layer of transparent slits and light scattering or fluorescent strips below the working surface and extending parallel to each other in one direction,
a second layer of transparent slits and reflecting or fluorescent strips below said first layer and extending parallel to each other in a direction perpendicular to the said one direction,
whereby movement of the pen over the working surface causes light from the tip of the pen either to be scattered upwardly by the first layer and/or to pass downwardly to said first and second layers or to stimulate light fluorescence from said first and second layers in a manner indicative of X and Y axis positions of the pen on the working surface,
at least one light sensor being provided to detect said scattered and/or transmitted or otherwise varied light, and
such stationary part having converting means operable to convert said sensed light to electrical signals indicative of at least an X or Y position of the pen and transmits said signals to a computer to effect corresponding positioning of a cursor on a visual display device thereof.

2. An input system according to claim 1 wherein said light sensor detects light scattered and/or transmitted or otherwise varied after transmission thereof into the tip of the pen.

3. An input system according to claim 1 wherein said light sensor is located adjacent said second layer to detect light transmitted thereinto.

4. An input system according to claim 1 wherein the first layer has a plurality of light transmitting relatively wide and relatively narrow slits and light scattering relatively wide and relatively narrow strips.

5. An input system according to claim 1 wherein the second layer has a plurality of light transparent relatively wide and relatively narrow slits and light reflecting relatively wide and relatively narrow strips.

6. An input system according to claim 1 wherein the first layer has plurality of light transmitting relatively wide and relatively narrow slits and relatively wide and relatively narrow trenches. The trenches containing fluorescent material which emits light at a first wavelength when excited by light from the pen, and the second layer has a plurality of light transmitting relatively wide and relatively narrow slits and relatively wide and relatively narrow second trenches, the second trenches containing fluorescent material which emits light at a second wavelength when excited by light from the pen.

7. An input system according to claim 1 wherein the pen has a vertically downwardly extending inoperative position with a tip thereof at the lower end.

8. An input system according to claim 1 wherein the working surface also has touch switches operable by engagement by the pen to effect movement of the cursor.
